(19) United States
(12) Patent Application Publication
(10) Pub. No.: US 2005/0227010 A1
(43) Pub. Date: Oct. 13, 2005

(54) Azetidinium-functionalised polymers and compositions containing the same

(76) Inventor: Andrew Philip Parker, Merseyside (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/506,390

(22) PCT Filed: Jan. 13, 2003
(86) PCT No.: PCT/EP03/00283

§ 371 Date: Sep. 2, 2004

(30) Foreign Application Priority Data
Mar. 6, 2002 (GB) 0205277.7

(51) Int. Cl. B05D 3/02

(52) U.S. Cl. 427/389.9; 528/272

(57) ABSTRACT

The invention provides a biodegradable azetidinium-functional polyester. This is useful for treating a substrate such as a cellulosic or keratinaceous textile material, preferably in the presence of a carrier. The polymer can be prepared by: a) reacting an amine-containing (di)acid or (di)ol with a suitable co-reactant, and,b) treating the product of step (a) with an epihalohydrin. Preferably step (a) occurs in the presence of a catalyst selected from the group comprising sulphuric acid, p-toluenesulphonic acid and a hafnium(IV) compound. The preferred diacid are iminodiacarboxylic acids in which each carboxylic acid moiety has a carbon number of 2-4. The preferred diols are polyalkylene glycols in which the repeat unit has a carbon number of 2-3.

### FIELD OF THE INVENTION

The invention relates to a biodegradable self-crosslinking polymer functionalised with azetidinium groups and to a fabric treatment composition which comprises the polymer. The invention further relates to the use in a domestic washing cycle or a tumble dryer of said composition.

### BACKGROUND AND PRIOR ART

A broad range of textile material treatments are known which involve the use of polymeric materials, both for treatment of textile materials in the form of whole cloth and in the form of finished garments. Some of these polymers are substantive. Many of these treatments are used in the garment supply chain to modify the ‘finish’ of garments.

Polyamidoamide-epichlorohydrin (PAE) resins are one particular class of materials which are known for the treatment of both keratinaceous and cellulosic materials. PAE resins are also well-known in the paper industry as alkaline curing wet-strength resins.

The epichlorohydrin resins are sometimes referred to below as amine-epichlorohydrin resins and polyamine-epichlorohydrin (PAE) resins (the terms being used synonymously).

The amine-epichlorohydrin resins may have one or more functional groups capable of forming azetidinium groups and/or one or more azetidinium functional groups. Alternatively, or additionally, the resins may have one or more functional groups that contain epoxide groups or derivatives thereof e.g. Kymene™ 450 (ex Hercules). Both of these classes of resin can cross-link or react with substrates as a result of the functional groups. During the curing reaction, covalent bonds are formed between polymers and fibres and between polymer molecules themselves.

It has been determined that the use of self-crosslinking polymers bearing the azetidinium group can impart many benefits to fabrics containing cellulosic materials (e.g. cotton). These benefits include improved wear resistance, reduced pilling, improved colour definition, reduced wrinkling and improved perfume longevity.

Patent W09207124A1 discloses the use of polyamidoamide-epichlorohydrin resins for the treatment of regenerated cellulose.

Patents W09742287A1, W09829530A2 and W09927065A1 disclose the use of polyamidoamide-epichlorohydrin resins in laundry detergents.

Patents W0008127A1, WO0131112A1, WO0131113A1, EP0978556A1, EP1096056A1 and EP1096060A1 disclose the use of polyamidoamide-epichlorohydrin resins for use as wrinkle-reducing agents in laundry detergents.

Patents WO0015747A1, WO0015748A1 and WO0163037A1 disclose the use of polyamidoamide-epichlorohydrin resins in rinse conditioner products.

Patent U.S. Pat. No. 4,198,269A1 discloses the use of polyamidoamide-epichlorohydrin resins in conjunction with an aminosilicone in a rinse product.

Patent WO0159053A1 discloses the use of an amphoteric azetidinium-functional polyurethane-urea-polyamide resin in conjunction with a cationic deposition aid in a rinse product.

Patent WO0127232A1 discloses the use of an azetidinium-functional polyoxyalkyleneamine.

Patents U.S. Pat. No. 4,156,775A1 and U.S. Pat. No. 4,198,269A1 disclose the synthesis of polymers containing pendant quaternary ammonium groups with azetidinium functionality for use on fibrous materials.

Polyamidoamide-epichlorohydrin resins are typically synthesised by a two-stage reaction. The first stage involves the reaction between a suitable triamine and a dicarboxylic acid. The most common materials used are diethylenetriamine and adipic acid. The secondary amine is then reacted with epichlorohydrin to form the azetidinium group.

It is known that the polyamidoamide-epichlorohydrin resins, available under the commercial trade names Kymene™ (Hercules), Kenores™ (Eka Nobel) are not readily or ultimately biodegradable.

Biodegradation generally relies on the action of enzymes, either from the ends of the polymer (exo-enzymes) or at random places along the backbone (endo-enzymes). Unless the polymer has suitable sites where these enzymes can bind, the polymer cannot be broken down. Therefore, for a polymer to be biodegradable, it must possess groups to which enzymes can bind.

It is believed that all the existing wet-strength resins do not contain suitable sites, and are thus not biodegradable.

### BRIEF DESCRIPTION OF THE INVENTION

We have devised azetidinium-functional polymers which are based on a backbone which contains a plurality of ester groups. These are particularly susceptible to hydrolysis and this assists in their biodegradation.

Accordingly, the present invention provides an azetidinium-functional polyester.

In a further aspect the present invention provides a method of treating a substrate which comprises the step of contacting the substrate with an azetidinium functionalised polyester.

Typical substrates include cellulosic and keratinaceous textile materials.

In a yet further aspect the present invention provides a composition comprising an azetidinium functionalised polyester and a substrate-compatible carrier.

Where the substrate is a textile, typical carriers include water and one or more surfactants.

The biodegradable polymer of the invention can be synthesised by reacting an amine-containing (di)acid or (di)ol with a suitable co-reactant.

Preferably the esterification reaction occurs in the presence of a suitable a suitable catalyst. Suitable catalysts include conc. sulphuric acid, p-toluenesulphonic acid and hafnium(IV) compounds. It is believed that the diol and diacid react by step polymerisation.

A diacid chloride can also be used in place of the dicarboxylic acid. In this case, no catalyst is required, the reaction between an acid chloride and an alcohol being much more reactive. Non-limiting examples include adipoyl chloride and sebacoyl chloride.

It is preferred that the diacid (or diacid chloride) is the amine containing material. This can be reacted with a non-amine diol. In the alternative the diol or both the co-monomers may contain the amine.

Suitable acids include the iminodiacarboxylic acids, preferably those in which each carboxylic acid moiety has a carbon number of 2-4. Iminodiacetic acid is a preferred acid.

Suitable diols include the polyalkylene glycols, preferably those in which the repeat unit has a carbon number of 2-3. Typically the glycol has a repeat number of 2-6. PEG 200 is a suitable diol.

Typically the water generated during the reaction is removed to prevent hydrolysis back to the acid/alcohol.

The reaction gives rise to an amine-containing polyester which can then be reacted with an epihalohydrin (preferably epichlorohydrin) to give the azetidinium-functional polyester.

This reaction is shown in schematic form below.

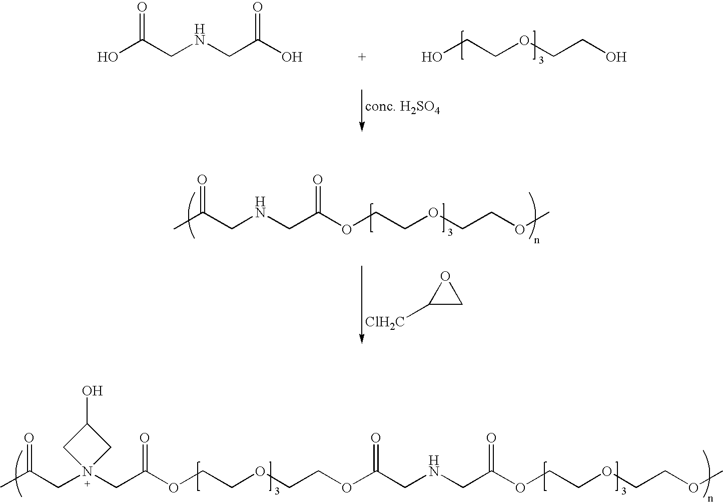

### DETAILED DESCRIPTION OF THE INVENTION

As noted above the compositions of the invention can comprise a textile-compatible carrier. Depending on the nature of this carrier the compositions of the invention may be presented as different product forms. The preferred forms are fully formulated textile treatment products, preferably laundry products. Further particulars of preferred features of the invention are given below.

Carriers and Product Form:

The compositions of this invention, when applied to a fabric, may be cured by a domestic curing step including ironing and/or tumble drying, preferably tumble drying.

Preferably, these curing steps are carried out at temperatures in the range 60 to 100° C., more preferably from 80 to 100° C.

The compositions of the invention may be used before, during or after a conventional laundry process and are preferably packaged and labelled as such. The laundry process includes large and small processes, and is preferably a domestic process.

Typically, the polymers of the invention will be used in conjunction with a textile compatible carrier.

In the context of the present invention the term “textile compatible carrier” is a component which can assist in the interaction of the polymer with the textile. The carrier can also provide benefits in addition to those provided by the first component e.g. softening, cleaning etc. The carrier may be a detergent-active compound or a textile softener or conditioning compound or other suitable detergent or textile treatment agent.

In a washing process, as part of a conventional textile washing product, such as a detergent composition, the textile-compatible carrier will typically be a detergent-active compound. Whereas, if the textile treatment product is a rinse conditioner, the textile-compatible carrier will be a textile softening and/or conditioning compound.

If the composition of the invention is to be used before, or after, the laundry process it may be in the form of a spray or foaming product.

The polymer is preferably used to treat the textile in the rinse cycle of a laundering process. The rinse cycle preferably follows the treatment of the textile with a detergent composition.

Detergent Active Compounds:

If the composition of the present invention is itself in the form of a detergent composition, the textile-compatible carrier may be chosen from soap and non-soap anionic, cationic, nonionic, amphoteric and zwitterionic detergent active compounds, and mixtures thereof.

Many suitable detergent active compounds are available and are fully described in the literature, for example, in “Surface-Active Agents and Detergents”, Volumes I and II, by Schwartz, Perry and Berch.

The preferred textile-compatible carriers that can be used are soaps and synthetic non-soap anionic and nonionic compounds.

Anionic surfactants are well-known to those skilled in the art. Examples include alkylbenzene sulphonates, particularly linear alkylbenzene sulphonates having an alkyl chain length of C₈-C₁₅; primary and secondary alkylsulphates, particularly C₈-C₁₅ primary alkyl sulphates; alkyl ether sulphates; olefin sulphonates; alkyl xylene sulphonates; dialkyl sulphosuccinates; and fatty acid ester sulphonates. Sodium salts are generally preferred.

Nonionic surfactants that may be used include the primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkylpolyglycosides, glycerol monoethers, and polyhydroxyamides (glucamide).

Cationic surfactants that may be used include quaternary ammonium salts of the general formula R₁R₂R₃R₄N⁺X⁻ wherein the R groups are independently hydrocarbyl chains of C₁-C₂₂ length, typically alkyl, hydroxyalkyl or ethoxylated alkyl groups, and X is a solubilising cation (for example, compounds in which R₁ is a C₈-C₂₂ alkyl group, preferably a C₈-C₁₀ or C₁₂-C₁₄ alkyl group, R₂ is a methyl group, and R₃ and R₄, which may be the same or different, are methyl or hydroxyethyl groups); and cationic esters (for example, choline esters) and pyridinium salts.

The total quantity of detergent surfactant in the composition is suitably from 0.1 to 60 wt % e.g. 0.5-55 wt %, such as 5-50 wt %.

Preferably, the quantity of anionic surfactant (when present) is in the range of from 1 to 50% by weight of the total composition. More preferably, the quantity of anionic surfactant is in the range of from 3 to 35% by weight, e.g. 5 to 30% by weight.

Preferably, the quantity of nonionic surfactant when present is in the range of from 2 to 25% by weight, more preferably from 5 to 20% by weight.

Amphoteric surfactants may also be used, for example amine oxides or betaines.

Builders:

The compositions may suitably contain from 10 to 70%, preferably from 15 to 70% by weight, of detergency builder. Preferably, the quantity of builder is in the range of from 15 to 50% by weight.

The detergent composition may contain as builder a crystalline aluminosilicate, preferably an alkali metal aluminosilicate, more preferably a sodium aluminosilicate.

The aluminosilicate may generally be incorporated in amounts of from 10 to 70% by weight (anhydrous basis), preferably from 25 to 50%. Aluminosilicates are materials having the general formula:
0.8-1.5 M₂O. Al₂O₃. 0.8-6 SiO₂
where M is a monovalent cation, preferably sodium. These materials contain some bound water and are required to have a calcium ion exchange capacity of at least 50 mg CaO/g. The preferred sodium aluminosilicates contain 1.5-3.5 SiO₂ units in the formula above. They can be prepared readily by reaction between sodium silicate and sodium aluminate, as amply described in the literature.
Textile Softening and/or Conditioner Compounds:

If the composition of the present invention is in the form of a textile conditioner composition, the textile-compatible carrier will be a textile softening and/or conditioning compound (hereinafter referred to as “textile softening compound”), which may be a cationic or nonionic compound.

The softening and/or conditioning compounds may be water insoluble quaternary ammonium compounds. The compounds may be present in amounts of up to 8% by weight (based on the total amount of the composition) in which case the compositions are considered dilute, or at levels from 8% to about 50% by weight, in which case the compositions are considered concentrates.

Compositions suitable for delivery during the rinse cycle may also be delivered to the textile in the tumble dryer if used in a suitable form. Thus, another product form is a composition (for example, a paste) suitable for coating onto, and delivery from, a substrate e.g. a flexible sheet or sponge or a suitable dispenser during a tumble dryer cycle.

Suitable cationic textile softening compounds are substantially water-insoluble quaternary ammonium materials comprising a single alkyl or alkenyl long chain having an average chain length greater than or equal to C₂₀. More preferably, softening compounds comprise a polar head group and two alkyl or alkenyl chains having an average chain length greater than or equal to C₁₄. Preferably the textile softening compounds have two, long-chain, alkyl or alkenyl chains each having an average chain length greater than or equal to C16.

Most preferably at least 50% of the long chain alkyl or alkenyl groups have a chain length of C₁₈ or above. It is preferred if the long chain alkyl or alkenyl groups of the textile softening compound are predominantly linear.

Quaternary ammonium compounds having two long-chain aliphatic groups, for example, distearyldimethyl ammonium chloride and di(hardened tallow alkyl) dimethyl ammonium chloride, are widely used in commercially available rinse conditioner compositions. Other examples of these cationic compounds are to be found in “Surface-Active Agents and Detergents”, Volumes I and II, by Schwartz, Perry and Berch. Any of the conventional types of such compounds may be used in the compositions of the present invention.

The textile softening compounds are preferably compounds that provide excellent softening, and are characterised by a chain melting Lβ to Lα transition temperature greater than 25° C., preferably greater than 35° C., most preferably greater than 45° C. This Lβ to Lα transition can be measured by DSC as defined in “Handbook of Lipid Bilayers”, D Marsh, CRC Press, Boca Raton, Fla., 1990 (pages 137 and 337).

Substantially water-insoluble textile softening compounds are defined as textile softening compounds having a solubility of less than 1×10⁻³ wt % in demineralised water at 20° C. Preferably the textile softening compounds have a solubility of less than 1×10⁻³ wt %, more preferably less than 1×10⁻⁸ to 1×10⁻⁶ wt %.

Especially preferred are cationic textile softening compounds that are water-insoluble quaternary ammonium materials having two C₁₂₋₂₂ alkyl or alkenyl groups connected to the molecule via at least one ester link, preferably two ester links. An especially preferred ester-linked quaternary ammonium material is di(tallowoxyloxyethyl) dimethyl ammonium chloride and/or its hardened tallow analogue. A second preferred type is 1,2-bis(hardened tallowoyloxy)-3-trimethylammonium propane chloride for which methods of preparation are, for example, described in U.S. Pat. No. 4,137,180 (Lever Brothers Co). Preferably these materials comprise small amounts of the corresponding monoester as described in U.S. Pat. No. 4,137,180, for example, 1-hardened tallowoyloxy-2-hydroxy-3-trimethylammonium propane chloride.

Other useful cationic softening agents are alkyl pyridinium salts and substituted imidazoline species. Also useful are primary, secondary and tertiary amines and the condensation products of fatty acids with alkylpolyamines.

The compositions may alternatively or additionally contain water-soluble cationic textile softeners, as described in GB 2 039 556B (Unilever).

The compositions may comprise a cationic textile softening compound and an oil, for example as disclosed in EP-A-0829531.

The compositions may alternatively or additionally contain nonionic textile softening agents such as lanolin and derivatives thereof.

Lecithins are also suitable softening compounds.

Nonionic softeners include Lβ phase forming sugar esters (as described in M Hato et al Langmuir 12, 1659, 1666, (1996)) and related materials such as glycerol monostearate or sorbitan esters. Often these materials are used in conjunction with cationic materials to assist deposition (see, for example, GB 2 202 244). Silicones are used in a similar way as a co-softener with a cationic softener in rinse treatments (see, for example, GB 1 549 180).

The compositions may also suitably contain a nonionic stabilising agent. Suitable nonionic stabilising agents are linear C₈ to C₂₂ alcohols alkoxylated with 10 to 20 moles of alkylene oxide, C₁₀ to C₂₀ alcohols, or mixtures thereof.

Advantageously the nonionic stabilising agent is a linear C₈ to C₂₂ alcohol alkoxylated with 10 to 20 moles of alkylene oxide. Preferably, the level of nonionic stabiliser is within the range from 0.1 to 10% by weight, more preferably from 0.5 to 5% by weight, most preferably from 1 to 4% by weight. The mole ratio of the quaternary ammonium compound and/or other cationic softening agent to the nonionic stabilising agent is suitably within the range from 40:1 to about 1:1, preferably within the range from 18:1 to about 3:1.

The composition can also contain fatty acids, for example C₈ to C₂₄ alkyl or alkenyl monocarboxylic acids or polymers thereof. Preferably saturated fatty acids are used, in particular, hardened tallow C₁₆ to C₁₈ fatty acids. Preferably the fatty acid is non-saponified, more preferably the fatty acid is free, for example oleic acid, lauric acid or tallow fatty acid. The level of fatty acid material is preferably more than 0.1% by weight, more preferably more than 0.2% by weight. Concentrated compositions may comprise from 0.5 to 20% by weight of fatty acid, more preferably 1% to 10% by weight. The weight ratio of quaternary ammonium material or other cationic softening agent to fatty acid material is preferably from 10:1 to 1:10.

Textile Treatment Products

The composition of the invention may be in the form of a liquid, solid (e.g. powder or tablet), a gel or paste, spray, stick or a foam or mousse. Examples include a soaking product, a rinse treatment (e.g. conditioner or finisher) or a main-wash product. The composition may also be applied to a substrate e.g. a flexible sheet or used in a dispenser which can be used in the wash cycle, rinse cycle or during the dryer cycle.

Liquid compositions may also include an agent which produces a pearlescent appearance, e.g. an organic pearlising compound such as ethylene glycol distearate, or inorganic pearlising pigments such as microfine mica or titanium dioxide (TiO₂) coated mica.

Liquid compositions may be in the form of emulsions or emulsion precursors thereof.

Composition may comprise soil release polymers such as block copolymers of polyethylene oxide and terephthalate.

Other optional ingredients include emulsifiers, electrolytes (for example, sodium chloride or calcium chloride) preferably in the range from 0.01 to 5% by weight, pH buffering agents, and perfumes (preferably from 0.1 to 5% by weight).

Further optional ingredients include non-aqueous solvents, perfume carriers, fluorescers, colourants, hydrotropes, antifoaming agents, antiredeposition agents, enzymes, optical brightening agents, opacifiers, dye transfer inhibitors.

In addition, compositions may comprise one or more of anti-shrinking agents, anti-wrinkle agents, anti-spotting agents, germicides, fungicides, anti-oxidants, UV absorbers (sunscreens), heavy metal sequestrants, chlorine scavengers, dye fixatives, anti-corrosion agents, drape imparting agents, antistatic agents and ironing aids. The lists of optional components are not intended to be exhaustive.

Treatment compositions for paper which comprise the polymer of the present invention will otherwise have the compositions known in that art.

In order that the invention may be further and better understood it will be described below with reference to several non-limiting examples.

### EXAMPLE

### Example 1

72 g of iminodiacetic acid (0.54 moles) and 108 g of PEG 200 (0.54 moles) were placed in a reaction vessel fitted with a temperature controller, Dean & Stark trap and water condenser. 0.5 ml of concentrated sulphuric acid was added and the mixture heated. The water evolved during the reaction was collected in the Dean & Stark trap.

Upon completion of the reaction, the viscous liquid was dissolved in water to give a concentration of 17%. The pH of the solution was adjusted to 10 with sodium hydroxide.

25 g of epichlorohydrin (0.27 moles) was added to the solution and heated to 50° C. for four hours. The level of epichlorohydrin was sufficient to functionalised half of the available secondary amines. At the end of the reaction, the product was acidified to pH 4 with hydrochloric acid.

### Example 2

A piece of black printed 100% woven cotton was taken and treated with 1% o.w.f. of the polymer obtained in Example 1, applied from a 2 g/l sodium hydrogen carbonate solution. A reference fabric was soaked in the same sodium hydrogen carbonate solution but without polymer. After application, the fabric was dried at 110° C. for 10 minutes. After conditioning for 24 hours at room temperature, the treated fabric was processed through a Quickwash™ system to determine the improvement in wear resistance provided by the polymer treatment. After completion of the test, the degree of wear was measured by measurement of the increase in lightness of the print.

Untreated fabric ΔE from new=9.59 (std. devn. 0.51)

Treated fabric ΔE from new=5.51 (std. devn. 0.33)

From these results it can be seen that fabrics treated with the fibre exhibit improved wear resistance.

### Example 3

36 g of iminodiacetic acid (0.27 moles) and 420 g of PEG1450 (0.29 moles) were placed in a reaction vessel equipped with a stirrer, Dean & Stark trap and condenser. 2.0 ml of concentrated sulphuric acid was added and the mixture heated for x hours until the expected quantity of water had been collected (12.2 ml). The mixture was then cooled. 400 ml of water was added to the polymer and the solution to give a product.

110 g of polymer in solution was then taken and the pH adjusted to 10 with sodium hydroxide. 25 ml of epichlorohydrin was added and the solution heated to 40° C. for four hours.

### Example 4

The self-crosslinking polyester prepared according to Example 3 was tested as in Example 1.

Untreated fabric ΔE from new=9.96 (std. devn. 0.47)

Treated fabric ΔE from new=4.48 (std. devn. 0.42)

From these results it can again be seen that the treated fabrics exhibit improved wear resistance.

1. An azetidinium-functional polyester.

2. A method of treating a substrate which comprises the step of contacting the substrate with a polyester according to claim 1.

3. A method according to claim 2 wherein the substrate comprises a cellulosic or keratinaceous textile material.

4. A composition comprising an azetidinium functionalised polyester according to claim 1 and a substrate-compatible carrier.

5. A composition according to claim 4 wherein the carrier comprises one or more of water and one or more surfactants.

6. A method of preparing a polyester according to claim 1 which comprises the step of:
a) reacting an amine-containing (di)acid or (di)ol with a suitable co-reactant, and,
b) treating the product of step (a) with an epihalohydrin.

7. A method according to claim 6 wherein the step (a) occurs in the presence of a suitable a catalyst selected from the group comprising sulphuric acid, p-toluenesulphonic acid and a hafnium(IV) compound.

8. A method according to claim 6 wherein the diacid is an amine.

9. A method according to claim 8 wherein the diacid is an iminodiacarboxylic acid in which each carboxylic acid moiety has a carbon number of 2-4.

10. A method according to claim 6 in which the diol is a polyalkylene glycol in which the repeat unit has a carbon number of 2-3.
